(19) United States
(12) Patent Application Publication
(10) Pub. No.: US 2021/0054211 A1
(43) Pub. Date: Feb. 25, 2021

(54) COMPOSITIONS INCLUDING LIGNIN AND METHODS FOR MAKING THE SAME

(71) Applicants: Simo Sarkanen, New Brighton, MN (US); Yi-ru Chen-Sarkanen, New Brighton, MN (US)

(72) Inventors: Simo Sarkanen, New Brighton, MN (US); Yi-ru Chen-Sarkanen, New Brighton, MN (US)

(21) Appl. No.: 16/982,818

(22) PCT Filed: Mar. 21, 2019
(86) PCT No.: PCT/US2019/023360

§ 371 Date: Sep. 21, 2020

Related U.S. Application Data
(60) Provisional application No. 62/645,940, filed on Mar. 21, 2018.

(51) Int. Cl. C08L 97/00; C08K 5/32; C08K 5/08

(52) U.S. Cl. CPC C08L 97/005; C08K 5/08; C08K 5/32

(57) ABSTRACT

A composition may include at least 50 wt-% of a first lignin component; and up to 50 wt % of a second lignin component. The first and second lignin components may include processed lignin or native lignin. The composition may include at least 80 wt-% processed lignin; and at least 1 wt-%) of a blend component comprising an aromatic ring and one or more electron withdrawing groups. The processed lignin may include kraft lignin or GVL lignin or both. The composition may include a lignin component and a non-lignin blend component. Polymeric articles formed from the composition by casting, molding, or extrusion may exhibit a tensile strength of 20 MPa or greater, or a tensile elongation at break of 1.5%> or greater.

### CROSS-REFERENCE TO RELATED APPLICATIONS

This application claims the benefit of U.S. Provisional Application No. 62/645,940, filed 21 Mar. 2018, the disclosure of which is incorporated by reference herein in its entirety.

### FIELD

The present disclosure relates to compositions that include a high concentration of lignin. In particular, the present disclosure relates to polymeric compositions and articles that include a high concentration of lignin.

### SUMMARY

The present disclosure provides compositions including at least 80 wt-% of processed lignin. The polymer articles may also contain at least 1 wt-% of a blend component comprising an aromatic ring and one or more electron withdrawing groups. The processed lignin may include kraft lignin, GVL lignin, or a mixture of at least two kinds of lignin. Articles formed from the composition by casting, molding, or extrusion may exhibit a tensile strength of 20 MPa or greater, or a tensile elongation at break of 1.5% or greater.

The present disclosure provides compositions including at least 50 wt-% of a first lignin component comprising processed lignin or native lignin; and up to 50 wt-% of a second lignin component comprising another processed lignin or native lignin. The processed lignin may include kraft lignin, GVL lignin, or a mixture of at least two kinds of lignin. Articles formed from the composition by casting, molding, or extrusion may exhibit a tensile strength of 20 MPa or greater, or a tensile elongation at break of 1.5% or greater.

The present disclosure provides polymer articles having a cast, molded, or extruded body comprising at least 50 wt-% lignin. The lignin may include processed lignin such as kraft lignin, GVL lignin, another processed lignin, native lignin, or a combination thereof. The polymer articles may exhibit a tensile strength of 20 MPa or greater, or a tensile elongation at break of 1.5% or greater.

The present disclosure provides polymer articles having a formed body comprising at least 50 wt-% non-sulfonated lignin. The lignin may include processed lignin such as kraft lignin, GVL lignin, another processed lignin, native lignin, or a combination thereof. The polymer articles may exhibit a tensile strength of 20 MPa or greater, or a tensile elongation at break of 1.5% or greater.

The present disclosure provides polymer articles including at least 80 wt-% lignin. The polymer articles may also contain at least 1 wt-% of a blend component comprising an aromatic ring and one or more electron withdrawing groups. The lignin may include processed lignin such as kraft lignin, GVL lignin, another processed lignin, native lignin, or a mixture of at least two kinds of lignin. The polymer articles may exhibit a tensile strength of 20 MPa or greater, or a tensile elongation at break of 1.5% or greater.

The present disclosure provides composition including 50 wt-% or more, or 80 wt-% or more of a first lignin component comprising ball milled lignin from a first source material; and 50 wt-% or more, or 80 wt-% or more of a second lignin component comprising ball milled lignin from a second source material different from the first source material.

### BRIEF DESCRIPTION OF DRAWINGS

FIG. 1 is a graphical representation of the results of Example 1, showing the tensile behavior of unmethylated ball-milled lignin-based polymeric materials composed of the lignin preparation alone (100% BML); corresponding blends with 2% poly(ethylene oxide-b-1,2-butadiene-b-ethylene oxide) (EBE), 5% poly(trimethylene glutarate) (PTMG), and 5% tetrabromobisphenol A (TBBP-A).

FIG. 2 is a graphical representation of the results of Example 2, showing the tensile behavior of kraft lignin-based polymeric materials composed of kraft lignin alone (100% KL), corresponding blends with 0.2% 9,10-anthraquinone; 5 m-dinitrobenzene; 5% 4-nitroaniline; 2% 1,4-anthraquinone; 5% 1,8-dinitroanthraquinone; 5% 3,5-dinitroaniline; and 5% Mₙ 1800 polyacrylamide.

FIG. 3 is a graphical representation of the results of Examples 3 and 4, showing the tensile behavior of lignin-based polymeric materials composed of filtered kraft lignin alone (100% KL), unfiltered kraft lignin alone (100% KL), gamma-valerolactone lignin alone (100% GVL), and a blend of filtered kraft lignin and gamma-valerolactone lignin (10% GVL, 90% KL).

FIG. 4 is a graphical representation of the results of Example 5, showing the tensile behavior of lignin-based polymeric materials composed of ball-milled softwood lignin alone, and a blend of 10% ball-milled corn-stover lignin (BMCSL) and 90% ball-milled softwood lignin (BML).

FIG. 5 is a graphical representation of the results of Example 6, showing the tensile behavior of kraft lignin-based polymeric materials composed of kraft lignin alone (100% KL), and corresponding blends with 5% 4-nitrophenyl nonyl ether; and 5% Mₙ 400 polyethylene glycol (PEG).

### DETAILED DESCRIPTION

The present disclosure relates to compositions that include a high concentration of lignin. In particular, the present disclosure relates to polymeric compositions and articles that include a high concentration (e.g., more than 75%, more than 85%, more than 90%, or more than 95%) of lignin. The lignin may include one or more types of processed lignin, lignin with a structure close to native lignin, native lignin, or a combination thereof.

The term “aromatic ring” is used in this disclosure to refer to a conjugated planar ring system of an organic compound. Aromatic rings may include carbon atoms only, or may include heteroatoms, such as oxygen, nitrogen, or sulfur.

The term “processed lignin” is used in this disclosure to describe lignin that has gone through one or more process steps that degrade (e.g., cleave) and/or otherwise change its chemical structure. An example of a process step that may degrade the chemical structure of lignin includes cooking in alkaline solution at high temperature under pressure in the presence of sulfur-based compounds (e.g., sulfides). An example of a process that utilizes such process steps is the kraft pulping process used to convert wood into wood pulp. An example of processed lignin is kraft lignin (“KL”). Kraft lignin is commercially available from, for example, Ingevity Corporation in North Charleston, S.C., U.S. Although lignin obtained through a gamma-valerolactone (“GVL”) process (for example, mildly acidic 80:20 GVL:water at 160-200° C.) has a structure close to native lignin in some analytical aspects, for the purposes of this disclosure, GVL lignin is considered a processed lignin. GVL lignin differs in structure from native lignin chiefly, but not exclusively, as a result of bond cleavage between some pairs of successive units in the native lignin chain.

The term “native lignin” is used in this disclosure to describe lignin that has not been chemically cleaved to a substantial extent or has not gone through a process that would substantially change or degrade its chemical structure. However, native lignin may have been mechanically cleaved. Native lignin may be obtained, for example, through a ball milling process that involves milling the source material (e.g., wood) along with inert balls followed by extraction with a solvent or solvent mixture. Other methods may also be used to produce native lignin, assuming that they do not chemically cleave a substantial amount (e.g., a majority) of the inter-monomer-unit bonds in the lignin. An example of native lignin includes ball milled lignin (“BML”).

The term “sulfonated” is used in this disclosure to describe compounds that include a sulfonate (—SO₃H) group. Sulfonated lignin is composed of lignin molecules that include a plurality of sulfonate groups. Sulfonated lignin (also known as lignosulfonate or ligninsulfonate) may be obtained from wood using a sulfite pulping process.

The term “alkylated” is used in this disclosure to describe compounds that are reacted to replace a hydrogen atom or a negative charge of the compound with an alkyl group, such that the alkyl group is covalently bonded to the compound. Thus, a hydroxyl group may be replaced, for example, by a methoxyl group.

The term “electron donating group” is used in this disclosure to describe an atom or functional group that donates some of its electron density into a conjugated π system making the π system more nucleophilic. Examples of electron donating groups include phenoxide (—O⁻), tertiary amines (—NR₂), secondary amines (—NHR), primary amine (—NH₂), alkoxy groups (—OR), phenol (—OH), amides (—NHCOR), alkyl, phenyl, and vinyl groups.

The term “electron withdrawing group” is used in this disclosure to describe an atom or functional group that withdraws electron density from a conjugated π system making the π system more electrophilic. Examples of electron withdrawing groups include trihalomethyl (e.g., —CF₃), cyano group (—C≡N), sulfonate (—SO₃H), ammonium (—NH₃⁺), quaternary ammonium (—NR₃⁺), nitro group (—NO₂), aldehyde (—CHO), ketone (—COR), carboxylic acid (—COOH), acyl chloride (—COCl), esters (—COOR), amide (—CONH₂), and halides.

The term “alkyl” is used in this disclosure to describe a monovalent group that is a radical of an alkane and includes straight-chain, branched, cyclic, and bicyclic alkyl groups, and combinations thereof, including both unsubstituted and substituted alkyl groups. Unless otherwise indicated, the alkyl groups typically contain from 1 to 30 carbon atoms. In some embodiments, the alkyl groups contain 1 to 20 carbon atoms, 1 to 10 carbon atoms, 1 to 6 carbon atoms, 1 to 4 carbon atoms, or 1 to 3 carbon atoms. Examples of alkyl groups include, but are not limited to, methyl, ethyl, n-propyl, n-butyl, n-pentyl, isobutyl, t-butyl, isopropyl, n-octyl, n-heptyl, ethylhexyl, cyclopentyl, cyclohexyl, cycloheptyl, etc.

The term “nitroaniline” is used in this disclosure to describe derivatives of aniline (C₆H₅NH₂) that contain one or more nitro groups (—NO₂). Examples of nitroanilines include 2-nitroaniline, 3-nitroaniline, 4-nitroaniline, 2,3-dinitroaniline, 2,4-dinitroaniline, 2,5-dinitroaniline, 2,6-dinitroaniline, 3,4-dinitroaniline, 3,5-dinitroaniline, and 2,4,6-trinitroaniline.

The term “anthraquinone” is used in this disclosure to describe derivatives of anthracene that include two oxo (═O) groups. Examples of anthraquinone include 1,4-anthraquinone, 9,10-anthraquinone, and 1,8-dinitroanthraquinone, among others. Anthraquinones may also include other substituent groups, for example electron donating groups and/or electron withdrawing groups.

The term “tensile strength” is used in this disclosure to refer to the capacity of a material to withstand a pulling (tensile) force before the material breaks, tears, rips, etc.

The term “tensile elongation” is used in this disclosure to refer to the percentage increase in length (elongation) of a material under stress (tension) before the material breaks.

All concentrations given as a percentage here are assumed to be on a weight basis (relative to the total dry weight of the material in question, excluding any residual solvent) unless otherwise stated.

The term “substantially” as used here has the same meaning as “significantly,” and can be understood to modify the term that follows by at least about 50%, at least about 75%, at least about 90%, at least about 95%, or at least about 98%. The term “not substantially” as used here has the same meaning as “not significantly,” and can be understood to have the inverse meaning of “substantially,” i.e., modifying the term that follows by not more than 50%, not more than 25%, not more than 10%, not more than 5%, or not more than 2%.

The term “about” is used here in conjunction with numeric values to include normal variations in measurements as expected by persons skilled in the art, and is understood have the same meaning as “approximately” and to cover a typical margin of error, such as ±5% of the stated value.

Terms such as “a,” “an,” and “the” are not intended to refer to only a singular entity, but include the general class of which a specific example may be used for illustration.

The terms “a,” “an,” and “the” are used interchangeably with the term “at least one.” The phrases “at least one of” and “comprises at least one of” followed by a list refers to any one of the items in the list and any combination of two or more items in the list.

As used here, the term “or” is generally employed in its usual sense including “and/or” unless the content clearly dictates otherwise. The term “and/or” means one or all of the listed elements or a combination of any two or more of the listed elements.

The recitations of numerical ranges by endpoints include all numbers subsumed within that range (e.g., 1 to 5 includes 1, 1.5, 2, 2.75, 3, 3.80, 4, 5, etc. or 10 or less includes 10, 9.4, 7.6, 5, 4.3, 2.9, 1.62, 0.3, etc.). Where a range of values is “up to” or “at least” a particular value, that value is included within the range.

The words “preferred” and “preferably” refer to embodiments that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure, including the claims.

Lignins are found in the cell-walls of all vascular plants including trees. As a class, they represent the second most abundant group of biopolymers on Earth. The profitable conversion of lignocelluloses from plants to liquid biofuels and commodity organic chemicals benefits from the value added to the co-product lignins. The cleavage of such lignin derivatives to low molecular weight compounds may look like a reasonable possibility, but the resistance to degradation and the broad range of cleavage-products formed can dampen enthusiasm for such undertakings.

Lignin macromolecules are composed of para-hydroxyphenylpropane units linked together through six or seven different carbon-oxygen or carbon-carbon bonds. Depending on the source of the lignin, the individual aromatic rings differ according to the frequency (zero, one or two) of attached methoxyl groups.

Softwood kraft lignin is a readily available, low cost raw material that may be derived as a by-product of the principal process employed in the United States for chemically converting wood chips into pulp for making paper. Useful lignin components may also be obtained from a number of other plant-based lignin-removing processes, including organosols, steam explosion, soda, autohydrolysis extraction processes, mechanical milling followed by extraction, and mildly acidic GVL-water treatment at about 160 to 200° C.

Pine kraft lignin is commercially available as INDULIN™ AT from the MeadWestvaco mill in Charleston, S.C., supplied by Ingevity Corp. For six decades, INDULIN has been considered to be a standard industrial softwood kraft lignin. It is isolated as a precipitate by acidifying “black” liquor from the linerboard-grade pulp that is formed after removing 70% of the lignin in wood through kraft pulping. Initially, the “white” kraft liquor (employed at a ˜7:2 liquor:wood ratio) may contain roughly 40 g/L NaOH, 5 g/L NaSH, 10 g/L Na₂S and 10 g/L Na₂CO₃ as chemical charges in the aqueous solution employed to treat wood chips at ˜170° C.

Another source of pine kraft lignin is the BIOCHOICE™ available from the Domtar mill in Plymouth, N.C., sourced from the “black” liquor formed when producing bleachable-grade pulp by removing 90% of the lignin in wood. Relative to the linerboard-grade pulp, this bleachable-grade pulp is created by using ˜30% higher chemical charges in the original “white” liquor and doubling the treatment time at the chosen temperature (˜170° C.).

The Ingevity and Domtar pulping conditions are thought to differ from one another considerably, and thus significant differences might be anticipated in the chemical structure and properties of the INDULIN and BIOCHOICE kraft lignins. Contrary to expectation, however, the two kraft lignins are surprisingly similar, the INDULIN AT possessing lower phenolic-hydroxyl group, catechol, enol-ether and stilbene contents, but higher methoxyl-group and β-O-4 alkyl-aryl-ether contents. Moreover, the apparent weight-average molecular weight (Mw) of the INDULIN AT is only about 3% lower than that of the BIOCHOICE kraft lignin.

For the past 60 years, an erroneous working hypothesis about the configuration of lignin macromolecules has diverted attention from the propriety of formulations for plastics with very high lignin contents. By 1960, the hydrodynamic behavior of ligninsulfonates was being interpreted as indicating that the constituent high molecular weight lignin species are crosslinked microgels. This was taken to imply that native lignin macromolecules are also crosslinked biopolymer chains. At that time, it was not thought that the hydrodynamic compactness of lignin macromolecules could arise from noncovalent interactions between the aromatic substructures. Just over 30 years ago, softwood delignification could still be analyzed through an elaboration of Flory-Stockmayer theory that sought to treat lignin dissolution in terms of crosslinked-gel degradation processes. Even 5 years ago, lignin macromolecules were adamantly described as hyperbranched. Of course, crosslinking and hyperbranching create rigid macromolecular structures that would lead to brittle materials in the absence of intervening soft segments along the polymer chains. For these reasons, incorporation limits of 40% for lignins in plastics have seldom been exceeded.

The present disclosure provides compositions that include a high concentration of lignin. For example, in some embodiments, the compositions are polymeric compositions and articles that include a high concentration (e.g., more than 75%, more than 85%, more than 90%, or more than 95%) of lignin. The lignin may be processed lignin (including lignin with a structure close to native lignin), native lignin, or a combination thereof. The lignin may include softwood lignin, hardwood lignin, lignins from other plant sources, or combinations thereof.

During certain stages of manufacturing, the composition may include a solvent. However, the amounts of the components of the composition are given here on a “dry” (e.g., solvent free) basis.

According to some embodiments, the composition includes at least 50 wt-%, at least 60 wt-%, at least 70 wt-%, at least 75 wt-%, at least 80 wt-%, at least 85 wt-%, at least 90 wt-%, at least 95 wt-%, at least 96 wt-%, at least 97 wt-%, at least 98 wt-%, at least 99 wt-% lignin, or 100 wt-% lignin. The composition may include one or more processed lignins and/or one or more native lignins and combinations thereof. In some embodiments, the composition includes two types of processed lignins. In some embodiments, the composition includes two types of native lignins. In some embodiments, the composition includes a processed lignin and a native lignin. In some embodiments, the composition includes at least 50 wt-%, at least 60 wt-%, at least 70 wt-%, at least 75 wt-%, at least 80 wt-%, at least 85 wt-%, at least 90 wt-%, at least 95 wt-%, at least 96 wt-%, at least 97 wt-%, at least 98 wt-%, or at least 99 wt-% processed lignin. In some embodiments, the processed lignin is kraft lignin, GVL lignin, or a combination thereof. The lignin may be filtered or unfiltered, or may include a blend of filtered and unfiltered lignins.

According to some embodiments, the composition includes non-sulfonated lignin. Further, in some embodiments the composition is free or substantially free of sulfonated lignin.

According to some embodiments, the composition includes non-alkylated lignin. Further, in some embodiments the composition is free or substantially free of alkylated lignin.

The composition may include one or more additional blend components. The additional blend components may be non-lignin components. The blend components may be selected to improve certain characteristics of the composition. For example, the blend components may be selected such that they act as plasticizers for the lignin. The blend components may further be selected such that they improve the physical properties, such as tensile strength and elongation, of the resulting polymer article. The blend component may be selected such that it is capable of forming a miscible blend with the lignin component.

The blend components may include polymeric components, oligomeric components, small molecules, or combinations thereof. Many compounds may have the desired effect of plasticizing the lignin component and/or improve the physical properties of the composition. It should be noted that polymeric, monomeric, oligomeric and small molecule blend components other than those exemplified herein are also envisioned.

Exemplary polymeric blend components include poly(ethylene oxide), poly(ethylene glycol) (PEG), poly(trimethylene glutarate) (PTMG), polycaprolactone, poly(trimethylene succinate), poly(ethylene succinate) (PES), and other main-chain aliphatic polyesters, poly(ethylene oxide-b-1,2-butadiene-b-ethylene oxide) (EBE), and the like.

Examples of small molecule blend components include compounds with one or more aromatic rings and one or more electron withdrawing groups. The one or more aromatic rings may include multi-ring structures. For example, the small molecule blend component may include three fused six-membered rings, where two of the rings are aromatic. The electron withdrawing group may be directly attached to an aromatic ring. In some embodiments, the compound also includes one or more electron donating groups, or an electron donating group in addition to the electron withdrawing group. The electron donating group may be conjugated with, or separated by two aromatic carbon atoms from, the electron withdrawing group. In some embodiments, the compound is a polyaromatic compound, such as an anthraquinone. The anthraquinone may include zero, one, or more electron withdrawing groups. The blend component may include a nitroaniline compound, such as 2-nitroaniline, 3-nitroaniline, 4-nitroaniline, 2,3-dinitroaniline, 2,4-dinitroaniline, 2,5-dinitroaniline, 2,6-dinitroaniline, 3,4-dinitroaniline, 3,5-dinitroaniline, 2,4,6-trinitroaniline, or a combination thereof. In one embodiment, the blend component is 4-nitroaniline or 3,5-dinitroaniline. The blend component may include an anthraquinone, such as 1,4-anthraquinone, 9,10-anthraquinone, 1,8-dinitroanthraquinone or the like.

The blends between lignin and non-lignin components are preferably composed of compatible molecular species. The blends are usually, but not necessarily, homogeneous. The intermolecular forces depend upon the functional groups and their arrangements on the chemical components. Thus, the prevailing intermolecular interactions may be governed by hydrogen bonding (involving hydroxyl and/or amino groups, for example); dipolar interactions that depend largely on π-electron withdrawing groups (e.g., carbonyl or nitro groups), and π-electron donating groups (e.g., methoxyl or amino groups); and/or electron correlation involving the aromatic lignin monomer units themselves. It is advantageous if the potential well that characterizes the variation in stabilization energy with relative lateral displacement between interacting molecular species, or segments thereof, allows significant movement to occur with little variation in interaction energy.

The composition may include any suitable level of blend components. For example, the amount of blend components may be selected to achieve a desired plasticizing effect, reduced brittleness, or improvement in physical (e.g., tensile) properties of the resulting polymer article. In some embodiments, the composition includes at least 0.1 wt-%, at least 0.2 wt-%, at least 0.5 wt-%, at least 1 wt-%, at least 2 wt-%, at least 3 wt-%, at least 4 wt-%, or at least 5 wt-% of blend components. The composition may include up to 20 wt-%, up to 15 wt-%, up to 12 wt-%, up to 10 wt-%, up to 8 wt-%, up to 6 wt-%, up to 5 wt-%, or up to 4 wt-% of blend components.

In some embodiments, the composition includes a mixture of a first lignin component and a second lignin component. For example, the first lignin component may include processed lignin and the second lignin component may include another processed lignin (different from the first lignin component), or native lignin. Alternatively, the first lignin component may include a native lignin, and the second lignin component may include another native lignin (different from the first lignin component), or a processed lignin. The first and second lignin components may be mixed at any suitable ratio. For example, the composition may include up to 2 wt-%, up to 5 wt-%, up to 8 wt-%, up to 10 wt-%, up to 20 wt-%, up to 25 wt-%, up to 30 wt-%, up to 40 wt-%, up to 50 wt-%, up to 75 wt-%, or up to 100 wt-% of the second lignin component. In some embodiments, the composition includes a majority of the first lignin component (e.g., processed lignin or a native lignin), and a balance of the second lignin component (e.g., another processed lignin or native lignin). In some embodiments, the first lignin component is kraft lignin and/or the second lignin component is GVL lignin. In some embodiments, the first lignin component is ball milled softwood lignin and the second lignin component is ball milled corn stover lignin. In some embodiments, the first and second lignin components are selected from kraft lignin, GVL lignin, and ball milled lignin. The lignins may be sourced from softwood, hardwood, or other plant materials (e.g., corn stover).

The composition may be used to produce polymer articles. For example, the composition may be cast (e.g., by solution casting), molded (e.g., compression molded, injection molded, or blow molded), or extruded to produce a formed body of a polymer article. Prior to forming the polymer article, the composition may be mixed, dissolved (e.g., in a solvent suitable for solution casting), and/or melt blended. The forming of the article may or may not follow immediately after or be simultaneous with the preparation of the composition.

Articles formed from the composition can be formed into or used as any type of structure including, for example, block structures (regular or irregular), sheet structures, fiber structures, or film structures. The term “formed body” is used here to refer to the body of a manmade article that has a physical form. Properties of the formed article that may be relevant or of interest may vary depending on the type of structure and the purpose for which the article is to be used. Exemplary properties that may be relevant can include, for example, mechanical properties such as tensile strength, elongation at break, ductility, plastic deformation, bending characteristics, impact resistance, and melt rheology. The polymer articles may also exhibit other beneficial properties, such as biodegradability.

In some embodiments, the polymer article made from the composition exhibits a tensile strength of at least 15 MPa, at least 18 MPa, at least 20 MPa, at least 25 MPa, at least 30 MPa, at least 35 MPa, or at least 40 MPa. There may be no desired upper limit for the tensile strength of the article. However, in practice, the polymer article may have a tensile strength of up to 70 MPa, up to 65 MPa, or up to 60 MPa.

In some embodiments, the polymer article made from the composition exhibits a tensile elongation at break of at least 1.5%, at least 2%, at least 3%, at least 4%, at least 5%, at least 7%, or at least 10%. There may be no desired upper limit for the tensile elongation at break of the article. However, in practice, the polymer article may have a tensile elongation at break of up to 200%, up to 100%, up to 50%, or up to 20%.

Objects and advantages are further illustrated by the following examples, but the particular materials and amounts thereof recited in these examples, as well as other conditions and details, should not be construed to unduly limit this disclosure.

### EXAMPLES

Purification of Softwood Kraft Lignin.

INDULIN AT from Ingevity Corp. was purified by dissolving in aqueous alkaline solution. It was then recovered from solution by acidification as a precipitate that was thoroughly washed with distilled water. After air-drying, the powder consisted of purified kraft lignin in ˜67% gravimetric yield.

Preparation of maple Gamma-valerolactone lignin (GVL lignin).

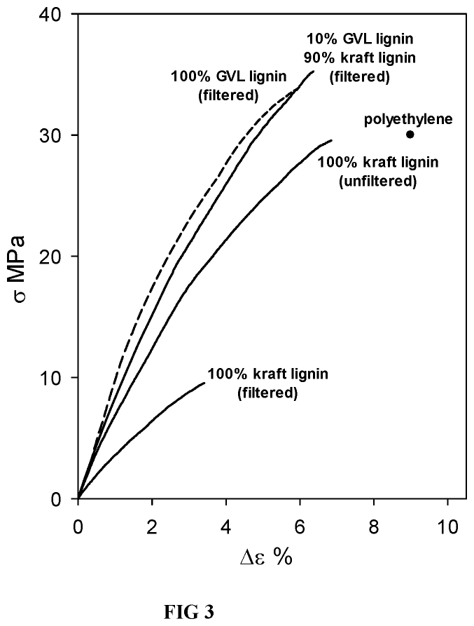

The GVL lignin used in the Examples was prepared according to a method described in Luterbacher, J. S., et al., Nonenzymatic sugar production from biomass using biomass-derived γ-valerolactone: Science 2014, 343, 277-280. Luterbacher et al. report that a homogeneous liquid mixture of, for example, ˜80:20 GVL:water containing less than 0.1 M H₂SO₄ can thermocatalytically saccharify lignocellulose as the biomass undergoes complete dissolution, bringing the carbohydrates and lignin into solution at ˜160-210° C. Comparable results are obtained with corn stover, hardwood (maple) and softwood (pine) in a flow-through reactor. A soluble lignin stream provides the co-product GVL lignin in a form suitable (after solvent evaporation) for valorization as a polymeric material approaching 100 wt-% in lignin content. Maple GVL lignin was used in the Example shown in FIG. 3.

Ball-milled softwood lignin (BML) isolation and purification. Jack pine 1.5 cm³ sapwood blocks were ground in a Wiley mill to a 40-mesh particle size. The resulting wood meal was Soxhlet-extracted with acetone for 48 h. The dry extractive-free wood meal was then milled in a cooled vibratory ball mill under N₂ for 48 h. A 40 g quantity of the ball-milled wood meal was suspended and stirred in dioxane:water (96:4 v/v) three consecutive times over 96 h. The extracts were centrifuged (3000 rpm, Beckman J6B, 30 minutes) and thereafter the solvents were removed by rotary evaporation. The lignin isolated was systematically purified by treatment with 9:1:4:18 v/v/v/v pyridine/acetic acid/water/chloroform whereupon, after solvent removal, the remaining material was dissolved in 2:1 v/v dichloroethane:ethanol and precipitated with ether. The carbohydrate content of the resulting product was so low that any monosaccharides liberated through acid catalysis could not be detected by standard chromatographic means.

Ball-milled corn-stover lignin (BMCSL) was extracted with aqueous 90% dioxane from corn stover that had been ball-milled for 4 days. The sample was reported (by D.K. Johnson at National Renewable Energy Laboratory (NREL)) to have a weight-average molecular weight (Mw) of 5900 with 81% lignin content and 6.3% carbohydrate content.

Preparation of Compositions and Polymer Articles.

To prepare each composition and polymer article, a 0.8 g quantity of the kraft lignin or GVL lignin preparation, with or without a blend component, was dissolved in 4.0 mL dimethyl sulfoxide (DMSO) to produce a solution that was then filtered through a fritted disc (4-5.5 μm pore size). Functional material continuity does not depend on this procedure, but the mechanical behavior of the cast lignin-based materials is appreciably affected. The solution was degassed at 70° C. in a 10×20 mm Teflon mold under reduced pressure in a vacuum oven, whereafter the temperature was raised stepwise to 150° C. or 180° C. over a 48-72 h period. In this process, the temperature approached and/or exceeded the glass transition temperature of the lignin preparation or lignin-based blend, as the case may be. The resulting rectangular plastic piece was filed to a 1-mm thick dog-bone-shaped test specimen, of which the typical distance between shoulders was about 6˜7 mm and the width about 5 mm.

Alternatively, a 0.6 g quantity of BML, with or without other blend components, was dissolved in 4.0 mL DMSO in a 10×20 mm Teflon mold at 50° C. After degassing under reduced pressure in a vacuum oven at 50° C. for 15 min, the BML test pieces were produced by solution-casting at 150° C. for a day and then 180° C. for 3 h.

Tensile Tests.

The tensile behavior of the prepared polymer articles (in the form of a dog-bone-shaped test piece) was characterized by means of a stress-strain curve measured with an INSTRON® model 5542 unit fitted with a 500 N static load cell. Serrated jaws were used to hold all test pieces in place. No tensile test was initiated until the load reading had become stable. A crosshead speed of 0.05 mm min⁻¹ was employed with specimen gauge lengths of 6˜7 mm. Young's modulus (E) and the stress (σₘₐₓ) and strain (ε_{σ,max}) at fracture were calculated on the basis of initial sample dimensions.

### Example 1

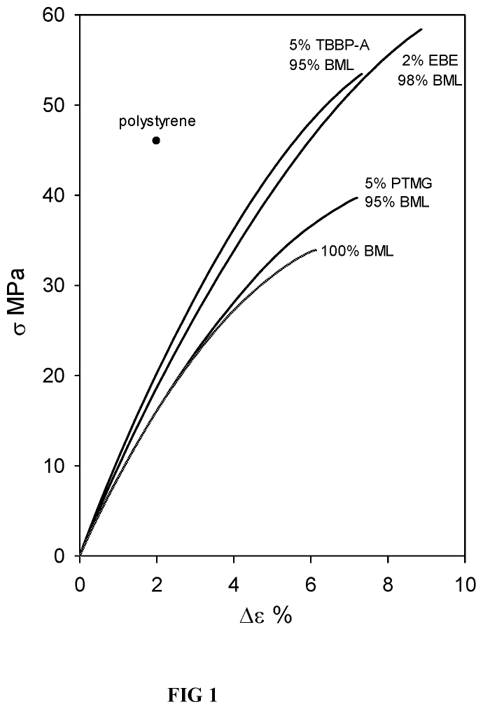

Ball milled lignin (BML) and blends of BML and one of 2% poly(ethylene oxide-b-1,2-butadiene-b-ethylene oxide) (EBE); 5% poly(trimethylene glutarate) (PTMG); and 5% tetrabromobisphenol A (TBBP-A) were prepared into polymer articles as described above, and as described in International Publication WO 2017/041082. The articles were tested for tensile behavior. The results are shown in FIG. 1.

It was observed that BML alone results in a tensile strength of about 34 MPa, and that the tensile strength of BML could be further improved by the inclusion of the tested blend components. Significantly, the inclusion of 2% poly(ethylene oxide-b-1,2-butadiene-b-ethylene oxide) (EBE); or 5% tetrabromobisphenol A (TBBP-A) resulted in tensile strengths of over 50 MPa.

### Example 2

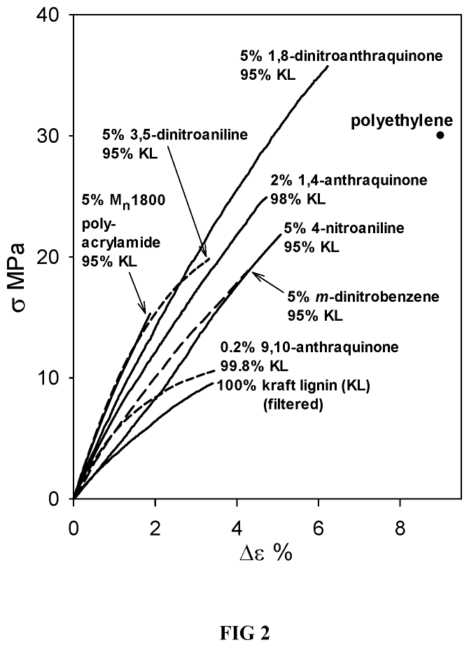

Kraft lignin (KL) and blends of KL and one of 0.2% 9,10-anthraquinone; 5% m-dinitrobenzene; 5% 4-nitroaniline; 2% 1,4-anthraquinone; 5% 1,8-dinitroanthraquinone; 5% 3,5-dinitroaniline; and 5% Mₙ 1800 polyacrylamide were prepared into polymer articles as described above. The articles were tested for tensile behavior. The results are shown in FIG. 2.

It was observed that 5% m-dinitrobenzene; 5% 4-nitroaniline; 2% 1,4-anthraquinone; and 5% 3,5-dinitroaniline improved the tensile properties of KL such that the tensile strength of the polymer article was approximately 20 MPa or greater, whereas 5% 1,8-dinitroanthraquinone provided a significant improvement, yielding a tensile strength of about 35 MPa.

### Example 3

Kraft lignin (KL), GVL lignin, and a blend of 90% KL and 10% GVL lignin were prepared into polymer articles as described above. The articles were tested for tensile behavior. The results are shown in FIG. 3.

It was observed that GVL lignin alone exhibits superior tensile properties as compared to KL alone. However, a 10% inclusion of GVL lignin in the KL was sufficient to improve the tensile properties of the KL blend to be comparable to the GVL lignin alone.

### Example 4

Unfiltered kraft lignin and filtered kraft lignin were prepared into polymer articles as described above. The articles were tested for tensile behavior. The results are also shown in FIG. 3.

It was observed that the unfiltered kraft lignin alone exhibits substantially superior tensile properties as compared to the filtered kraft lignin alone.

### Example 5

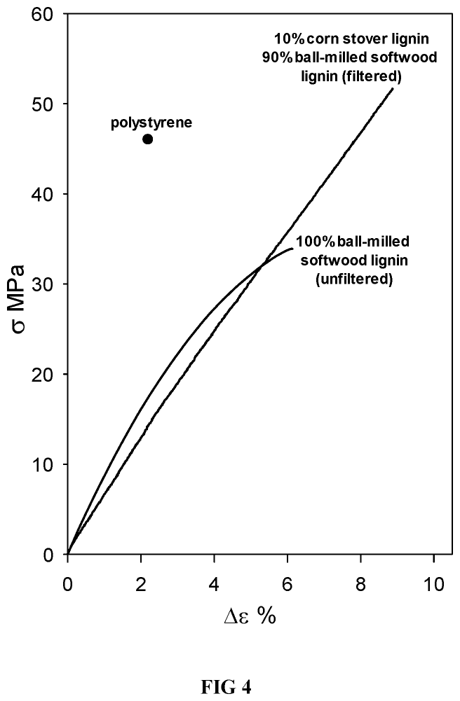

Ball-milled lignin (BML) and corn-stover lignin (BMCSL) were blended at a ratio of 90/10 and prepared into polymer articles as described above. The prepared polymer articles were tested for tensile behavior. The results are shown in FIG. 4 for the filtered blend alongside the 100% unfiltered BML sample from Example 1.

It was observed that the blend of 90% BML and 10% BMCSL resulted in a polymeric material with tensile strength and elongation-at-break above the corresponding parameters for polystyrene.

### Example 6

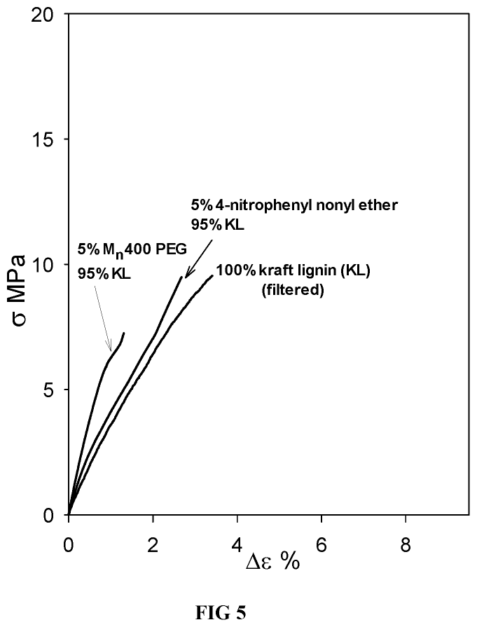

A large number of blend components were tested. The above Examples demonstrate several blend components that provided significant improvements to the tensile properties of KL-based polymers and BML-based polymers at concentrations ranging from 2 to 10 wt-%. However, many of the tested blend components were not as successful. Some combinations of KL and the blend component were too brittle for mechanical testing. Two examples of components (5% 4-nitrophenyl nonyl ether; and 5% Mn 400 polyethylene glycol (PEG)) that were tested but did not significantly improve the tensile properties of KL at similar inclusion levels are shown in FIG. 5.

Embodiments of compositions including lignin are disclosed. The implementations described above and other implementations are within the scope of the following claims. One skilled in the art will appreciate that the present disclosure can be practiced with embodiments other than those disclosed. The disclosed embodiments are presented for purposes of illustration and not limitation.

1. A composition comprising:
at least 80 wt-% of processed lignin; and
at least 1 wt-% of a blend component.

2. (canceled)

3. The composition of claim 1, wherein the processed lignin comprises kraft lignin.

4. The composition of claim 1, wherein the lignin is not sulfonated.

5. The composition of claim 1, wherein the blend component comprises an electron donating group, an electron withdrawing group, or both.

6. The composition of claim 1, wherein the blend component comprises a nitroaniline, an anthraquinone, or a combination thereof.

7. (canceled)

8. The composition of claim 1, wherein articles formed from the composition by casting, molding, or extrusion exhibit a tensile strength of 20 MPa or greater.

9. The composition of claim 1, wherein articles formed from the composition by casting, molding, or extrusion exhibit a tensile elongation at break of 1.5% or greater.

10. A composition comprising:
at least 80 wt-% of a first lignin component; and
up to 20 wt-% of a second lignin component different from the first lignin component.

11. The composition of claim 10, wherein the first lignin component comprises kraft lignin.

12. (canceled)

13. The composition of claim 10, wherein the composition is substantially free of sulfonated lignin.

14. The composition of claim 10, further comprising a blend component comprising an aromatic ring and an electron withdrawing group, an electron donating group, or both an electron withdrawing group and an electron donating group.

15. The composition of claim 10, wherein articles formed from the composition by casting, molding, or extrusion exhibit a tensile strength of 20 MPa or greater; a tensile elongation at break of 1.5% or greater; or both.

16. A polymer article comprising:
a cast, molded, or extruded body comprising at least 85 wt-% processed lignin.

17. (canceled)

18. The polymer article of claim 16, wherein the processed lignin comprises kraft lignin.

19. (canceled)

20. (canceled)

21. The polymer article of claim 16, wherein the processed lignin comprises a blend of a first processed lignin and a second processed lignin.

22. (canceled)

23. The polymer article of claim 16 further comprising a blend component comprising an aromatic ring and an electron withdrawing group, an electron donating group, or both an electron withdrawing group and an electron donating group.

24. (canceled)

25. The polymer article of claim 16, wherein the blend component comprises a nitroaniline, an anthraquinone, or a combination thereof.

26. (canceled)

27. The polymer article of claim 16, wherein the polymer article exhibits a tensile strength of 20 MPa or greater.

28. The polymer article of claim 16, wherein the polymer article exhibits a tensile elongation at break of 1.5% or greater.

29-53. (canceled)

54. The polymer article of claim 16, wherein the cast, molded, or extruded body comprises:
90 wt-% or greater of processed lignin; and
1 wt-% or greater of a non-lignin blend component,
wherein the polymer article exhibits a tensile strength of 20 MPa or greater and a tensile elongation at break of 1.5% or greater.
